(19) United States
(12) Patent Application Publication
(10) Pub. No.: US 2018/0082392 A1
(43) Pub. Date: Mar. 22, 2018

(54) SYSTEMS AND METHODS FOR SELECTING COMMUNICATION CHANNELS TO IMPROVE STUDENT OUTCOMES

(71) Applicant: Full Measure Education Inc., Washington, DC (US)

(72) Inventors: Paul Miller, Arlington, VA (US); Christopher Davidson, Washington, DC (US); Gregory Davies, Washington, DC (US)

(21) Appl. No.: 15/711,723

(22) Filed: Sep. 21, 2017

Related U.S. Application Data
(60) Provisional application No. 62/398,350, filed on Sep. 22, 2016.

(51) Int. Cl. G06Q 50/20; G06Q 10/06

(52) U.S. Cl. CPC G06Q 50/2053; G06Q 10/063114; G06Q 10/0635

(57) ABSTRACT

A communication campaign manager can be configured to assist academic administrators to communicate effectively with students. The campaign manager can be configured to assess student risk for each of a plurality of individual students based on various factors, which may include demographic information, financial aid information, and academic information about the students. The campaign manager can assign students to different quadrant prioritizations based on their individual risk scores. The campaign manager also can assign a weighting to different forms of communication or communication channels, based on various risk factors. The campaign manager can use such information to generate a communication campaign for administrators to use in communicating with students, which can help to improve student engagement and academic success.

### FIELD OF DISCLOSURE

The present disclosure is generally directed to various systems and methods for managing an electronic communication campaign to improve student outcomes in an academic setting.

### BACKGROUND

Traditional techniques used by administrators in an academic setting to communicate with students are inefficient. Particularly in higher education, research shows that many students drop out of school for reasons that may be unrelated to their academic experience. For example, students may have a difficult time connecting their career aptitudes and vision for the future to their choice of an educational pathway that leads to a good-paying job. Many students also lack family or peer support. This lack of vision for the future can cause students to lose motivation to continue with their education, even if they are capable of succeeding academically. Furthermore, administrative processes can be difficult for many students to navigate. For example, the administrative processes for adding and dropping classes or changing academic programs can be confusing for students, and student frustration with such processes can result in students deciding not to continue with their education. These problems can be addressed by communication from administrators to students to provide the students with the information and resources they may need to navigate administrative processes. However, traditional techniques for communicating with students are inefficient and may not adequately address the most difficult issues students deal with. Additionally, traditional techniques for communicating with students often direct communications towards students who are unlikely to benefit from such communications, thereby wasting valuable human capital, computing, and network resources.

### BRIEF SUMMARY

Aspects and implementations of the present disclosure are generally directed to systems and methods for managing a communication campaign, such as via electronic communications, to improve student outcomes in an academic setting. In particular, the systems and methods of the present solution are directed to the technical problems and challenges of assessing risk factors on an individual student basis, assigning weights to various communication strategies or channels based on various risk factors, and selecting proper communication channels, as well as determining an order in which to communicate with students, in a computer-based technology and platform. Existing computer-based technologies and platforms do not effectively and efficiently make use of the computing and network resources deployed for such computer-based technologies and platforms to include such functionality. Without implementing such functionality, existing computer-based technologies and platforms suffer from various problems. For example, existing technologies and platforms are not capable of assessing student risk on an individual basis and based on a variety of different factors, and are not capable of determining an improved selection of communication channels and timing for delivering communications to students to provide students with the information and resources they need to continue their education and succeed academically.

The systems and methods of the present solution are directed to the improvement of the performance and operation of the computer-based technology and platform and computing and networking resource used by such a computer-based technology and platform. In some aspects, the present solution improves and enhances the implemented functionality of the computer-based technology and platform implemented on, integrated with and inherently tied to a processor, memory, network and computing resources of one or more computing devices. In some aspects, the present solution more effectively performs the functionality of the computer-based technology and platform, thereby making and causing more effective use of the computing and networking resources to achieve the improved functionality of the present solution. The same computing and network resources used by such a computer-based technology and platform provide increased and improved functionality with implementation of the present solution. In some aspects, the present solution more efficiently uses the computing and networking resources to implement the improved functionality of the computer-based technology and platform.

In some implementations, a novel and non-conventional electronic communication campaign manager can be configured to assist academic administrators to communicate effectively with students. The communication campaign manager can be configured to assess student risk for each of a plurality of individual students based on various factors, which may include demographic information, financial aid information, and academic information about the students. The communication campaign manager can assign students to different quadrant prioritizations based on their individual risk scores. In some implementations, the communication campaign manager also can assign a weighting to different forms of communication or communication channels, based on various risk factors. The communication campaign manager can then use all of this information to generate a communication campaign for administrators to use in communicating with students, which can help to improve student engagement and academic success. In some implementations, the communication campaign can include a selection of communication channels to use for various communications, as well as an order which students should be communicated with throughout the campaign. These selections can be made by the communication campaign manager in a manner that facilitates greater student engagement based on the factors discussed above. The details of various embodiments of the present solution are set forth in the accompanying drawings and the description below.

One aspect of the disclosure is directed to a method for selecting an order of communications based on risk scores and resources. The method can include determining, by a risk scoring engine executing on one or more devices, a risk score for each of a plurality of students based on information on each of the plurality of students stored in a database. The method can include assigning, by a quadrant prioritization engine executing on the one or more devices, each of the plurality of students to a quadrant level of a plurality of quadrant levels based on the risk score determined for each of the plurality of students. The method can include assigning, by a communication campaign generator, a level of resources from a predetermined plurality of resources to each quadrant level. The method can include selecting, by the communication campaign generator, an order for communicating with the plurality of students based on the quadrant level assigned to each student and the level of resources assigned to each quadrant level. The method can include communicating, by the communication campaign generator, to each of the plurality of students based on the selected order.

In some implementations, the method can further include determining, by the risk scoring engine, for each student the risk score corresponding to a risk score category of a plurality of risk score categories. In some implementations, the method can further include determining the risk score based on information comprising demographic information, financial aid information and academic information.

In some implementations, the method can further include determining, by a communication strategy engine, weightings for each of a plurality of communication strategies based on a plurality of risk factors. In some implementations, the method can further include selecting the order based on the quadrant level assigned to each student and the level of resources assigned to each quadrant level and the weightings for each of the plurality of communication strategies. In some implementations, the method can further include determining weightings based on relevance of risk score category to type of communication strategy.

In some implementations, the method can further include determining, by the communication campaign generator, a priority level for each of a plurality of communication campaigns to be communicated to one or more of the plurality of students. In some implementations, the method can further include selecting the order based on the quadrant level assigned to each student and the level of resources assigned to each quadrant level and the priority level of each of the plurality of communication campaigns. In some implementations, the method can further include selecting at least one communication channel from a plurality of communication channels over which a communication campaign is to be communicated to one or more of the plurality of students. In some implementations, the plurality of communication channels can include at least two or more of the following: email, text, telephone and push notifications via an application.

Another aspect of this disclosure is directed to a system for selecting an order of communications based on risk scores and resources. The system can include one or more devices comprising a processor, coupled to memory. The system can include a risk scoring engine executable on the one or more devices and configured to determine a risk score for each of a plurality of students based on information on each of the plurality of students stored in a database. The system can include a quadrant prioritization engine executable on the one or more devices and configured to assign to each of the plurality of students to a quadrant level of a plurality of quadrant levels based on the risk score determined for each of the plurality of students. The system can include a communication campaign generator executable on the one or more devices and configured to assign a level of resources from a predetermined plurality of resources to each quadrant level. The communication campaign generator can be further configured to select an order for communicating with the plurality of students based on the quadrant level assigned to each student and the level of resources assigned to each quadrant level. The communication campaign generator can be further configured to communicate to each of the plurality of students based on the selected order.

In some implementations, the risk scoring engine can be further configured to determine for each student the risk score corresponding to a risk score category of a plurality of risk score categories. In some implementations, the risk scoring engine can be further configured to determine the risk score based on information comprising demographic information, financial aid information and academic information.

In some implementations, the system can further include a communication strategy engine configured to determine weightings for each of a plurality of communication strategies based on a plurality of risk factors. In some implementations, the order can be selected based on the quadrant level assigned to each student and the level of resources assigned to each quadrant level and the weightings for each of the plurality of communication strategies. In some implementations, the communication strategy engine can be further configured to determine weightings based on relevance of risk score category to type of communication strategy.

In some implementations, the communication campaign generator can be further configured to determine a priority level for each of a plurality of communication campaigns to be communicated to one or more of the plurality of students. In some implementations, the order can be selected based on the quadrant level assigned to each student and the level of resources assigned to each quadrant level and the priority level of each of the plurality of communication campaigns. In some implementations, at least one communication channel from a plurality of communication channels can be selected over which a communication campaign is to be communicated to one or more of the plurality of students. In some implementations, the plurality of communication channels can include at least two or more of the following: email, text, telephone and push notifications via an application.

### BRIEF DESCRIPTION OF THE FIGURES

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein;

FIG. 2 is a block diagram of an example system for managing an electronic communication campaign;

FIG. 3 is flowchart of an example method for managing an electronic communication campaign; and

FIGS. 4A and 4B are screenshots of example graphical user interfaces for managing an electronic communication campaign.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein.

Section B describes embodiments of systems and methods for monitoring medical device sales and usage.

A. Computing and Network Environment

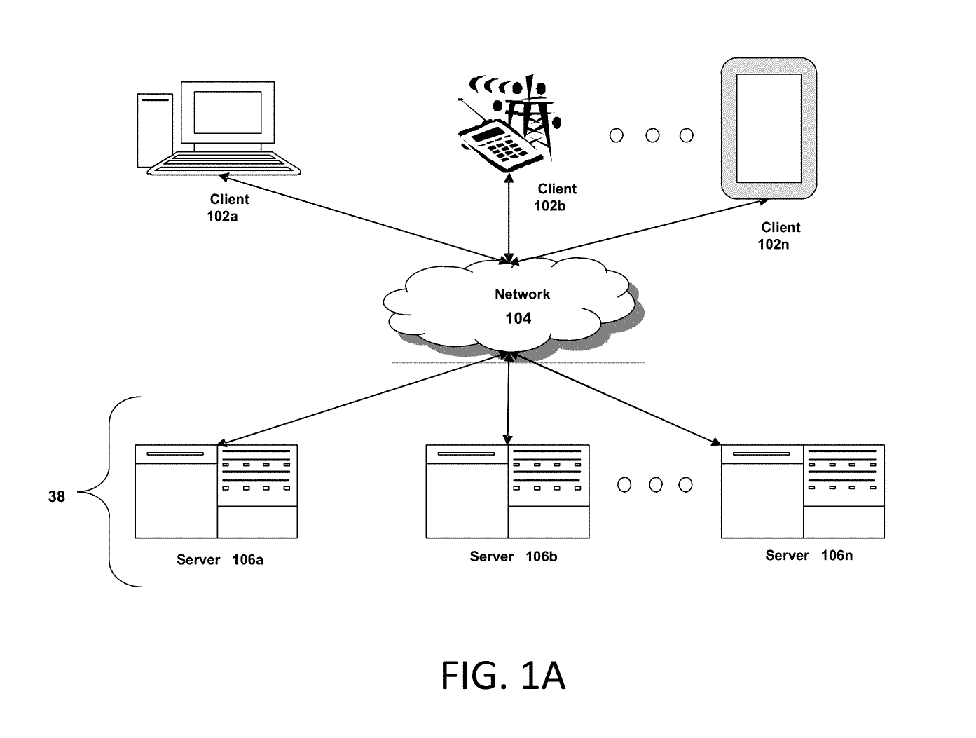

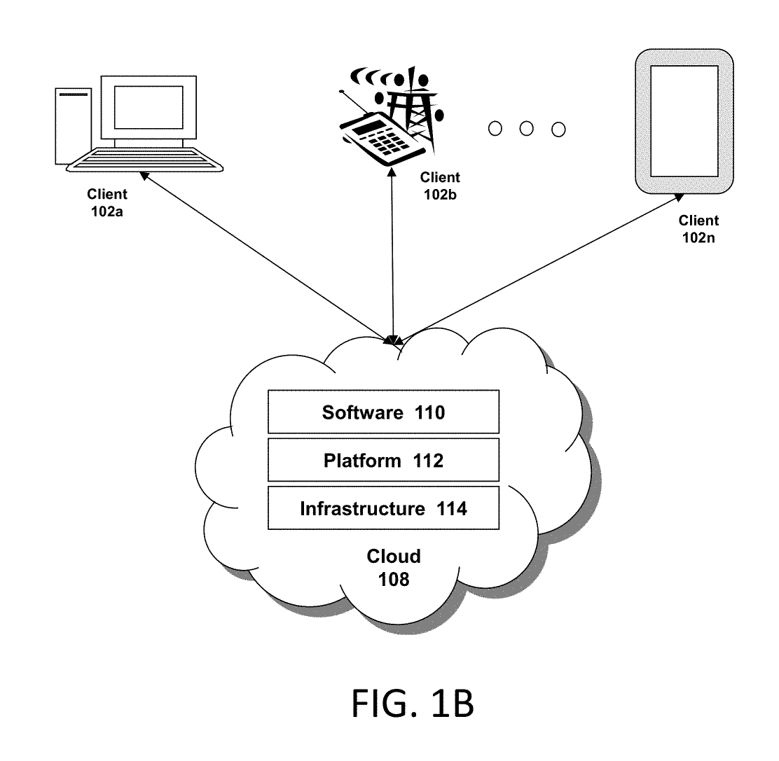

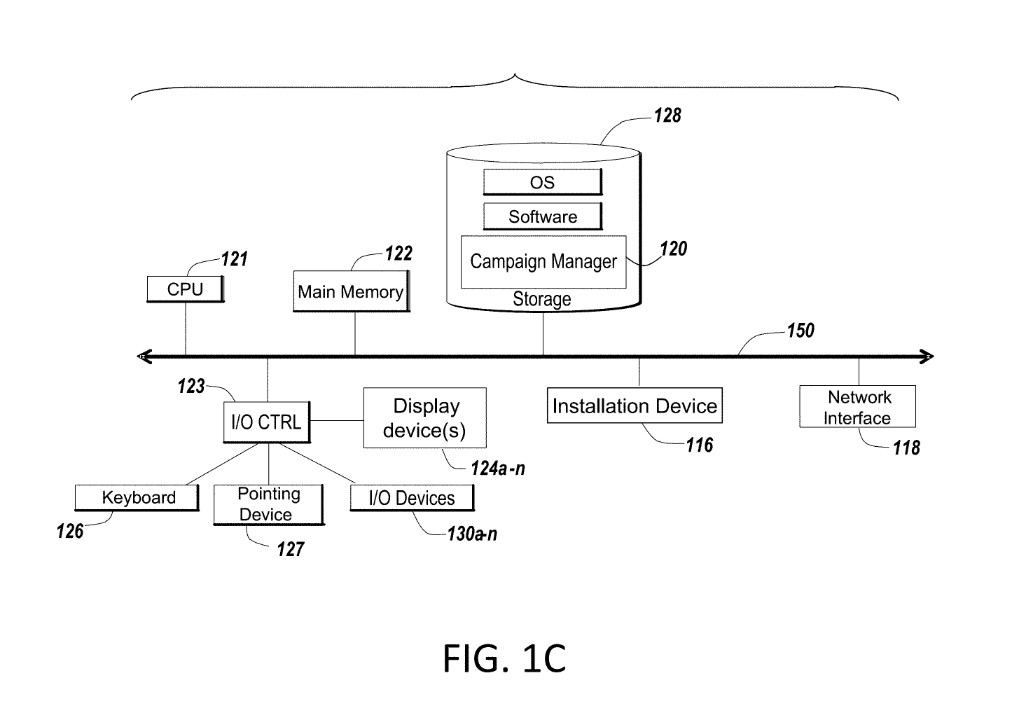

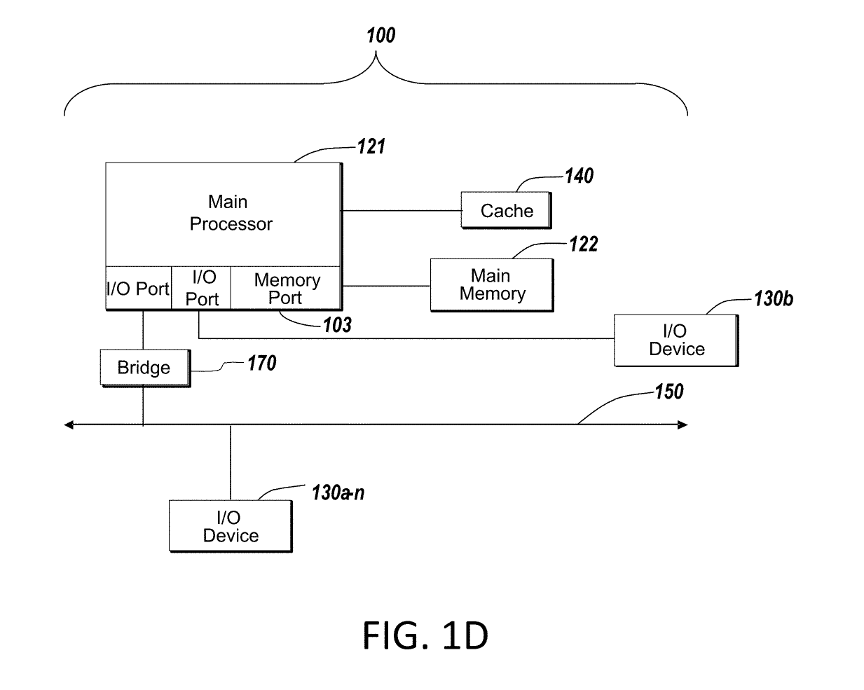

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS can include infrastructure and services (e.g., EG-32) provided by OVH HOSTING of Montreal, Quebec, Canada, AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a communication campaign manager 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AND PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WIT, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software for the communication campaign manager 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2022, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 are monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

B. Managing an Electronic Communication Campaign

Aspects and implementations of the present disclosure are generally directed to systems and methods for managing a communication campaign to improve student outcomes in an academic setting. In particular, the systems and methods of the present solution are directed to the technical problems and challenges of assessing risk factors on an individual student basis, assigning weights to various communication strategies or channels based on various risk factors, and selecting proper communication channels, as well as an order in which to communicate with students, in a computer-based technology and platform. Existing computer-based technologies and platforms do not effectively and efficiently make use of the computing and network resources deployed for such computer-based technologies and platforms to include such functionality. Without implementing such functionality, existing computer-based technologies and platforms suffer from various problems. For example, existing technologies and platforms are not capable of assessing student risk on an individual basis and based on a variety of different factors, and are not capable of determining an improved selection of communication channels and timing for delivering communications to students to provide students with the information and resources they need to continue their education and succeed academically.

The systems and methods of the present solution are directed to the improvement of the performance and operation of the computer-based technology and platform for creating, managing and executing communication campaigns to the student population and computing and networking resource used by such a computer-based technology and platform. In some aspects, the present solution improves and enhances the implemented functionality of the computer-based technology and platform, described herein and implemented on, integrated with and inherently tied to a processor, memory, network and computing resources of one or more computing devices. In some aspects, the present solution more effectively performs the functionality of the computer-based technology and platform for creating, managing and executing communication campaigns with students, thereby making and causing more effective use of the computing and networking resources to achieve the improved functionality of the present solution. The same computing and network resources used by such a computer-based technology and platform provide increased and improved functionality with implementation of the present solution. In some aspects, the present solution more efficiently uses the computing and networking resources to implement the improved functionality of the computer-based technology and platform. For example, in some implementations, a novel and non-conventional electronic communication campaign manager can be configured to assist academic administrators to communicate effectively with students. The communication campaign manager can be configured to assess student risk for each of a plurality of individual students based on various factors, which may include demographic information, financial aid information, and academic information about the students. The communication campaign manager can assign students to different quadrant prioritizations based on their individual risk scores. In some implementations, the communication campaign manager also can assign a weighting to different forms of communication or communication channels, based on various risk factors. The communication campaign manager can then use all of this information to generate a communication campaign for administrators to use in communicating with students, which can help to improve student engagement and academic success. In some implementations, the communication campaign can include a selection of communication channels to use for various communications, as well as an order which students should be communicated with throughout the campaign. These selections can be made by the communication campaign manager in a manner that facilitates greater student engagement based on the factors discussed above. The details of various embodiments of the present solution are described further below.

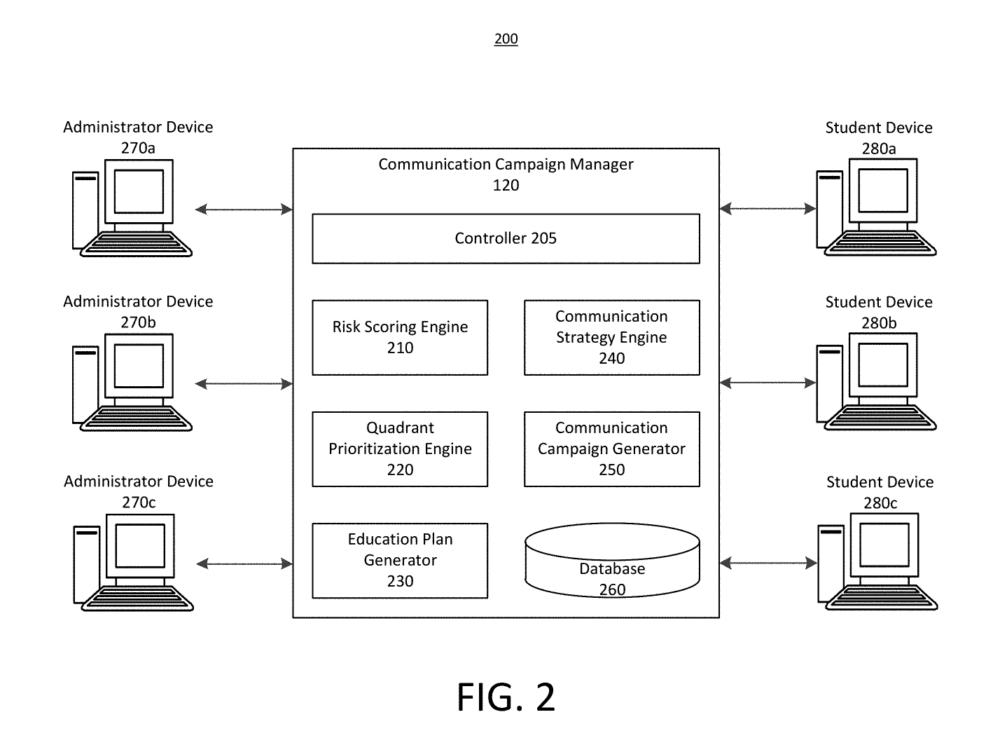

FIG. 2 is a block diagram of an example system 200 for managing an electronic communication campaign. The system 200 includes the communication campaign manager 120, which is communicatively coupled to a plurality of administrator devices 270a-270c (generally referred to as administrator devices 270) and a plurality of student devices 280a-280c (generally referred to as student devices 280). In brief overview, the communication campaign manager 120 can include a controller 205, a risk scoring engine 210, a quadrant prioritization engine 220, an education plan generator 230, a communication strategy engine 240, a communication campaign generator 250, and a database 260. The details of the various components of the system 200 are described further below.

The communication campaign manager 120 is coupled to each of the administrator devices 270 and each of the student devices 280. In some implementations, the administrator devices 270 and the student devices 280 can be implemented using any type of computing device. For example, the administrator devices 270 and the student devices 280 may be servers, desktop computers, laptop computers, tablet computers, or mobile communication devices such as smartphones. It should be noted that, while only three administrator devices 270 and three student devices 280 are shown for illustrative purposes, the system 200 may include more or fewer administrator devices 270 and student devices 280 than are depicted in FIG. 2. For example, in some implementations, the system 200 may include tens, hundreds, or thousands of administrator devices 270 and tens, hundreds, or thousands of student devices 280. In general, an administrator device 270 may be any computing device that is owned, managed, used, or accessed by an administrator in an academic setting. For example, an administrator may be an employee of any administrative department in a college or university, such as a member of an admissions department or a member of a student services department. Likewise, a student device 280 may be any computing device that is owned, managed, used, or accessed by students in the academic setting.

In implementations in which the student devices 280 are implemented as mobile devices, each of the student devices 280 also may be configured to execute a mobile application that may serve as part of a communication campaign. In some implementations, the mobile application may be configured to provide information to users of the student devices 280 (e.g., students) relating to administrative processes that students may be required to complete in order to progress through their academic programs. For example, the mobile application can be configured to provide information to students regarding the processes for registering for classes or applying for financial aid. Likewise, the administrator devices 270 also may be configured to execute a mobile application, which may serve as a companion to the mobile application executed by the student devices 280. For example, the mobile application executed by the administrator devices 270 can be configured to allow administrators to communicate information to the student devices 280 belonging to or used by those students who are most likely to benefit from such information. In some implementations, the mobile application executed by the administrator devices may be configured to display a dashboard graphical user interface allowing a user to view a current status or metrics associated with an ongoing communication campaign, or to change parameters associated with such a campaign. In some implementations, computer instructions corresponding to the mobile applications may be stored, for example, in the database 260. Administrator devices 270 and student devices 280 may be configured to download the mobile applications from the database 260, thereby allowing the mobile applications to be installed on the administrator devices 270 and student devices 280.

In some implementations, the communication campaign manager 120 can be a computing device such as a server. In some other implementations, the communication campaign manager 120 can be implemented as another form of computing device, such as a desktop computer, a laptop computer, a tablet computer, or a mobile computing device. In still other implementations, the communication campaign manager 120 may be implemented as a cluster of computing devices that are communicatively coupled to one another via a computer network. For example, the communication campaign manager 120 can be a cluster of servers coupled to one another within a datacenter network. The communication campaign manager 120 may include output devices, such as one or more display screens, as well as input devices, such as one or more keyboards, touchscreens, or pointing devices that allow a user to interact with the communication campaign manager 120. In some implementations, some or all of the functionality of the communication campaign manager 120 can be automated by a computer program that executes on the communication campaign manager 120, such that the communication campaign manager 120 can perform some or all of the functions described further below without receiving instructions from a human user. In some implementations, each of the modules depicted within the communication campaign manager 120 may be implemented as a separate computing device or separate logic, which may be networked together to form the communication campaign manager 120.

In some implementations, the risk scoring engine 210 can be configured to assess the risk of each student failing to achieve an expected outcome. For example, one expected outcome could be re-registering for an upcoming academic semester. In another example, the expected outcome may be graduating within a predetermined time frame. The risk scoring engine 210 can be configured to assess risk on an individual student basis. Thus, each student may be assigned a risk score by the risk scoring engine based on the student's unique risk factors. In some implementations, risk factors may fall into a variety of categories. For example, one risk factor used by the risk scoring engine 210 may be an academic risk factor. In some implementations, the academic risk factor for a student may be based on the student's past grades or exam scores. In some implementations, for example, the risk scoring engine 210 may be configured to determine a lower value for the academic risk factor of a student based on relatively high grades or exam scores. Similarly, the risk scoring engine 210 may be configured to determine a higher value for the academic risk factor of a student based on relatively low grades or exam scores. In some implementations, the risk scoring engine may receive information about a student's academic history from the database 260. For example, the database 260 can be configured to store academic transcripts for students as well as other academic information. The risk scoring engine 210 can be configured to retrieve such academic information from the database 260. The risk scoring engine 210 can then process the retrieved academic information to assess the academic risk for each student.

In some implementations, the risk scoring engine 210 also may assess student risk based on demographic information. Demographic information may include any social or economic data about a student. For example, demographic information may include a student's age and gender, as well as information about the student's family, such as whether or not the student has a parent who completed college. In some implementations, such data may be submitted by students during the application process, and may subsequently be stored in the database 260.

In some implementations, the risk scoring engine 210 also may assess student risk based on financial information. Financial information may include the value of assets owned by the student or by the student's family, and a current income level for the student or the student's family. Such information may be included on a student application for financial aid, and may subsequently be stored in the database 260. The risk scoring engine 210 can retrieve this information for each student from the database, and can evaluate the information to determine student risk. For example, the risk scoring engine 210 may determine that a student's risk of failing to register for classes for an upcoming semester is higher based on a determination that the student has access to relatively few financial resources.

In some implementations, the risk scoring engine 210 also may assess student risk based on a student's tendency to procrastinate. For example, procrastination information may be measured as a historical time taken by the student before taking action on open items, such as tasks that must be completed in order to enroll in classes. Such historical data can be stored in the database 260 for access by the risk scoring engine 210. In some implementations, the risk scoring engine may determine that a student is at increased risk of failing to enroll in classes based on the student's past procrastination.

In some implementations, the risk scoring engine 210 may generate risk scores using numerical values. In some other implementations, the risk scoring engine 210 may generate risk scores represented as letters. In some implementations, the risk scoring engine can be configured to generate separate score for each of the factors it assesses. As described above, the risk scoring engine 210 may consider factors such as academic risk, demographic risk, financial risk, and procrastination risk. It should be understood that these risk score categories are illustrative only, and that in some implementations, the risk scoring engine 210 can be configured to assess any other risk score category to generate a risk score for a student. In some implementations, the risk scoring engine 210 also can generate an overall risk score for a student, based on the assessment of student risk in each of the factors assessed by the risk scoring engine 210. For example, the risk scoring engine 210 may generate an overall risk score for a student by taking an average of the risk scores associated with each risk factor category. In some other implementations, the risk scoring engine 210 may generate an overall risk score by using a weighted average of the risk scores associated with each risk factor category, in which some of the weights are different from others.

The quadrant prioritization engine 220 can be configured to assign students into different quadrant prioritization levels based on the assigned risk scores. For example, based on the risk scores for each student, the quadrant prioritization engine 220 may determine that certain students should be prioritized more highly than others, as they may be more likely to benefit from more aggressive communications sent by the administration. On the other hand, the quadrant prioritization engine 220 may determine that some students are unlikely to benefit from additional communications, and may assign such students may to lower quadrant prioritization levels as a result. The quadrant prioritization engine 220 may assign students to any number of quadrant prioritization levels. For example, in some implementations, the quadrant prioritization engine 220 may assign students to any of two, three, four, five, or six quadrant prioritization levels. In some implementations, the quadrant prioritization engine 220 may assign students to more than six quadrant prioritization levels.

Table 1 below presents example quadrant prioritization levels that can be generated by the quadrant prioritization engine 220 for each of six risk scores:

TABLE 1

| Risk Score | Quadrant Level |
|---|---|
| F | 6 |
| E | 4 |
| D | 3 |
| C | 2 |
| B | 1 |
| A | 5 |

In this example, risk scores are based on a letter scoring system using letters from A-F, with A indicating the lowest level of risk and F indicating the highest level of risk. As discussed above, the risk scores can be generated, for example, by the risk scoring engine 210. The quadrant prioritization engine 220 can be configured to generate an integer having a value of 1-6 for each of the six risk scores. Lower numbers indicate higher levels of priority. The quadrant prioritization engine 220 can be configured to select higher priority levels for students who are more likely benefit from communications from the administration. Thus, in this example, the quadrant prioritization engine 220 has selected a relatively low quadrant level for students having an “A” risk score. As discussed above, the “A” risk score represents the lowest level of risk. Therefore, the quadrant prioritization engine 220 can determine that students whose risk score is “A” are at such low risk for failing to register that no resources should be used to reach these students. For example, these students are likely highly motivated and do not require additional reminders or information from the administration in order to register for classes. Therefore, the quadrant prioritization engine 220 can determine that it would not be worthwhile to prioritize these students over other students when allocating communication resources.

The education plan generator 230 can be configured to produce an education plan for each student. In some implementations, the education plan generator 230 can generate education plans based on information about the students stored in the database 260. For example, information such as students' academic history and stated career interests can be stored in the database 260. The education plan generator 230 can be configured to retrieve this information, and can use the information to generate an education plan for each student that is appropriate based on the information retrieved from the database 260. For example, the education plan generator 230 can be configured to determine a set of one or more courses that are relevant to a student's stated career objectives, and to determine the courses that the student has already completed. The education plan generator 230 can then determine which of the relevant courses have not yet been completed, and can add those courses to the student's education plan. In some implementations, the education plan generator 230 can be configured to transmit the education plan directly to the student device 280 belonging to the student associated with the education plan. In some other implementations, the education plan generator 230 can transmit the education plan to one or more of the administrator devices 270. In still other implementations, another module such as the controller 205 may be configured to receive an education plan from the education plan generator 230 and to transmit the education plan to any of the student devices 280 or any of the administrator devices 270.

The communication strategy engine 240 can be configured to generate a weighting for each of a plurality of risk factors based on various communication strategy types. In one example, the communication strategy type may relate to registration. The registration communication strategy may involve encouraging students to register for courses that do not have existing financial blocks to registration. Table 2 below presents example weightings that may be generated by the communication strategy engine 240 for each of the risk factors described above (i.e., procrastination, academic, financial, and demographic) for the registration communication strategy:

TABLE 2

| | Relevance to Communication |
|---|---|
| Risk Score Category | Strategy Type (Registration) |
| Procrastination | 100 |
| Academic | 0 |
| Financial | 0 |
| Demographic | 100 |

As shown in Table 2, the communication strategy engine 240 may select relatively high weights for the procrastination and demographic risk score categories, and relatively low weights for the academic and financial risk score categories. For example, because registering for classes likely requires students to actively take steps to enroll, a history of procrastination for a student may indicate that the student is at increased risk of failing to complete registration, and as a result the communication strategy engine 240 may assign a relatively higher weight to the procrastination category. Similarly, because the registration communication strategy relates only to courses that have no existing financial blocks to registration, the communication strategy engine 240 can determine that the financial risk score category is irrelevant to this communication strategy and can assign it a relatively low weight (e.g., a weight of zero, as shown in Table 2).

In another example, the communication strategy type may relate to completing a financial aid checklist. Table 3 below presents example weightings that may be generated by the communication strategy engine 240 for each of the risk factors described above (i.e., procrastination, academic, financial, and demographic) for the financial aid checklist communication strategy:

TABLE 3

| | Relevance to Communication |
|---|---|
| Risk Score Category | Strategy Type (Registration) |
| Procrastination | 50 |
| Academic | 0 |
| Financial | 100 |
| Demographic | 50 |

As shown in Table 3, the communication strategy engine 240 may select a relatively high weighting for the financial risk score category, as the financial aid checklist communication strategy relates directly to student finances. Because the financial aid checklist communication strategy does not relate to academics, the communication strategy engine 240 may select a relatively low weighting for the academic risk factor in this example.

It should be appreciated that the values shown in Tables 2 and 3 above, as well as the details regarding their respective examples, are illustrative only. Many other communication strategies may be available, and the communication strategy engine 240 may be configured to select a range of values for the weighting associated with risk score categories for different communication strategies. For example, as discussed above, the student devices 280 may be configured to execute a mobile application that serves as part of a communication campaign to provide students with information they may need regarding administrative processes. In at least one example, the communication strategy type may relate to encouraging students to download and install the mobile application itself. In such an example, the communication strategy engine 240 may be configured to select relatively low weightings for risk factors such as the academic risk score category, which may not be highly relevant to a student's likelihood of completing a download and install process for a mobile application. However, the communication strategy engine 240 may be configured to select relatively high weightings for more relevant risk factors, such as the procrastination risk factor.

The communication campaign generator 250 can be configured to process the information generated or otherwise provided by the other modules, as well as additional information that may be provided by the administrator devices 270, to produce a communication campaign that can be used to help improve student outcomes. The communication campaign may include a list of students arranged by the order in which the students should be communicated with to achieve the best results. In some implementations, the communication campaign also may specify the times at which communications should be delivered to students, as well as specifying a timing interval that between successive communications during the campaign. In some implementations, the communication campaign generator 250 can use information such as the available resources to generate the communication campaign. In some implementations, the communication campaign generator 250 also may take into account the priority level of a campaign as compared to other campaigns. Priority information may be received, for example, from the administrator devices 270.

In some implementations, the communication campaign generator 250 can be configured to select communication channels over which communications for a campaign should be delivered to students. For example, such channels may include emails, telephone calls, text messages, paper mail, or push notifications delivered to devices such as the student devices 280. As discussed above, the student devices 280 can be configured to execute a mobile application that facilitates the communication campaign. In some such implementations, the communication campaign may include communications sent to the student devices 280 via the mobile application, such as push notifications associated with the mobile application. Furthermore, the communication campaign may include sending other types of information to the student devices 280, such as information corresponding to calendar appointments for one or more calendar applications that may execute on the student devices 280. In some implementations, the communication campaign may include messages that request information from the students. For example, such messages may be delivered to the student devices 280 and may request that student provide information (e.g., in the form of a survey) relating to their knowledge or level of completion for various administrative processes. In some implementations, information provided by the students in response to such communications may be stored, for example, in the database 260.

Table 4 below shows an example of how the communication campaign generator 250 may account for differing levels of available resources (e.g., differing amounts of computing resources, network resources, bandwidth, human capital hours, etc.):

TABLE 4

| Risk | | 40 Resource | 20 Resource | 10 Resource |
|---|---|---|---|---|
| Score | Quadrant Level | Units Available | Units Available | Units Available |
| F | 6 | 100% | 0% | 0% |
| E | 4 | 100% | 0% | 0% |
| D | 3 | 100% | 100% | 0% |
| C | 2 | 100% | 100% | 50% |
| B | 1 | 100% | 100% | 100% |
| A | 5 | 100% | 0% | 0% |

As shown in Table 4, the risk score and quadrant level columns are identical to those described above in connection with Table 1. Table 4 also shows that the communication campaign generator 250 can adjust the communication approach based on the amount of resource units available. In general, a resource unit may refer to any combination of a variety of resources that may be useful for a campaign. For example, resources may include computing resources (e.g., a number of computers available, a processing speed of the available computers, an amount of memory available to the computers, etc.), network resources (e.g., available bandwidth, network speed, etc.), or human capital (e.g., a number of combined hours during which human employees can work). The concept of a resource unit may refer to any combination of such resources, and may also account for a prioritization of such resources. In this example, it can be assumed that using all active channels to contact every student in every quadrant prioritization level would require 40 resource units. Thus, when 40 resource units are available, the communication campaign generator 250 can determine that 100% of students in each quadrant prioritization level should be contacted. However, when fewer than 40 resource units are available, the communication campaign generator 250 may select groups of students to prioritize over others. For example, when 20 resource units are available, the communication campaign generator 250 can determine that all students in the first, second, and third quadrant prioritization levels should be contacted, thereby consuming all of the available resource units. Students in the fourth, fifth, and sixth quadrant prioritization levels are not contacted, as there are no additional resource units available for contacting these students. When only 10 resource units are available, the communication campaign generator 250 can determine that 100% of students in the first quadrant prioritization level should be contacted using active channels, and 50% of students in the second quadrant prioritization level should be contacted. Due to a lack of resource units, the remaining 50% of students in the second quadrant prioritization level, as well as all of the students in the third through sixth quadrant prioritization levels, should not be contacted.

In some implementations, the communication campaign generator 250 can be used to generate a plurality of simultaneous communication campaigns, each of which may be associated with a different priority level. For example, Table 5 below shows the order in which students should be contacted to satisfy three simultaneous campaigns, according to one example:

TABLE 5

| | | | Medium | |
|---|---|---|---|---|
| | | Low Priority | Priority | High Priority |
| Risk Score | Quadrant Level | Campaign | Campaign | Campaign |
| A | 5 | 17 | 10 | 8 |
| B | 1 | 11 | 5 | 1 |
| C | 2 | 12 | 6 | 2 |
| D | 3 | 13 | 7 | 3 |
| E | 4 | 14 | 9 | 4 |
| F | 6 | 18 | 16 | 15 |

In Table 5, the risk score and quadrant level columns are identical to those described above in connection with Table 1. Each cell in the remainder of Table 5 includes an integer indicating the order in which students should be communicated with to satisfy all three of the simultaneous campaigns, as determined by the communication campaign generator 250. Lower numbers indicate higher priority. For example, the communication campaign generator 250 can determine that students in the first quadrant prioritization level should be contacted in connection with the high priority campaign first, followed by students the second through fourth quadrant prioritization levels for that campaign. As shown, the last group of students to be communicated with include those in quadrant prioritization level 6 for the low priority campaign. In some implementations, after the communication campaign generator 250 has generated the campaign, it may transmit information corresponding to the campaign to the administrator devices 270, thereby allowing the administrators to carry out the campaign.

In some aspects, the system 200 of the present solutions implements a combination of the controller 205, the risk scoring engine 210, the quadrant prioritization engine 220, the education plan generator 230, the communication strategy engine 240, the communication campaign generator 250, and the database 260 in an innovative, non-conventional and/or non-routine manner. In some aspects, the system of the present solutions integrates a controller 205, a risk scoring engine 210, a quadrant prioritization engine 220, an education plan generator 230, a communication strategy engine 240, a communication campaign generator 250, and a database 260 in an innovative, non-conventional and/or non-routine manner to implement the improved functionality, performance and operation of the present solution. In some aspects, the system of the present solutions integrates a controller 205, a risk scoring engine 210, a quadrant prioritization engine 220, an education plan generator 230, a communication strategy engine 240, a communication campaign generator 250, and a database 260 in an innovative, non-conventional and/or non-routine manner to more efficiently and effectively use computing and networking resources. The controller 205, a risk scoring engine 210, a quadrant prioritization engine 220, an education plan generator 230, a communication strategy engine 240, a communication campaign generator 250, and a database 260 are integrated in an innovative, nonconventional manner to mitigate, reduce, prevent, or resolve the technical problems of assessing student risk on an individual basis based on a variety of different factors, and determining an improved selection of communication channels and timing for delivering communications to students to provide students with the information and resources they need to continue their education and succeed academically.

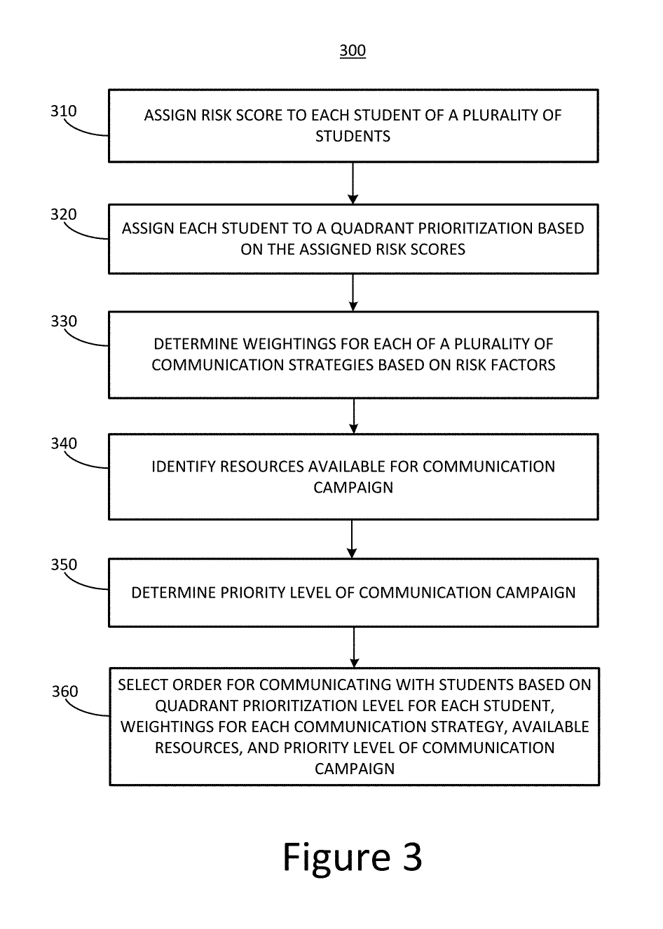

FIG. 3 is flowchart of an example method 300 for managing an electronic communication campaign. In some implementations, the method 300 can be used to generate and execute a communication campaign for communicating with students in an academic setting, in order to improve the likelihood that more students will achieve various desired outcomes. In brief overview, the method 300 can include assigning a risk score to each student of a plurality of students (step 310), assigning each student to a quadrant prioritization based on the assigned risk scores (step 320), determining weightings for each of a plurality of communication strategies based on a plurality of risk factors (step 330), identifying resources available for the communication campaign (step 340), determining a priority level of the communication campaign (step 350), and selecting an order for communicating with the students based on the quadrant prioritization for each student, the weightings for each communication strategy, the available resources, and the priority level of the communication campaign (step 360).

Referring again to FIG. 3, and in greater detail, the method 300 can include assigning a risk score to each student of a plurality of students (step 310). In some implementations, risk scores may be assigned by a module such as the risk scoring engine 210 shown in FIG. 2. In some implementations, the risk scoring engine can be configured to assess the risk of each student failing to achieve an expected outcome. For example, one expected outcome could be re-registering for an upcoming academic semester. The risk scoring engine can be configured to assess risk on an individual student basis. Thus, each student may be assigned a risk score by the risk scoring engine based on the student's unique risk factors. In some implementations, risk factors may fall into a variety of categories. For example, risk factors may include an academic risk factor. In some implementations, the academic risk factor for a student may be based on the student's past grades or exam scores. In some implementations, for example, the risk scoring engine may be configured to determine a lower value for the academic risk factor of a student based on relatively high grades or exam scores. Risk factors also may include demographic risk factors, financial risk factors, and risk factors related to a student's tendency to procrastinate.

In some implementations, the risk scoring engine may generate risk scores using numerical values. In some other implementations, the risk scoring engine may generate risk scores represented as letters. In some implementations, the risk scoring engine can be configured to generate separate score for each of the factors it assesses. In some implementations, the risk scoring engine also can generate an overall risk score for a student, based on the assessment of student risk in each of the factors assessed by the risk scoring engine. For example, the risk scoring engine may generate an overall risk score for a student by taking an average of the risk scores associated with each risk factor category. In some other implementations, the risk scoring engine may generate an overall risk score by using a weighted average of the risk scores associated with each risk factor category, in which some of the weights are different from others.

In some implementations, the method 300 can include assigning each student to a quadrant prioritization based on the assigned risk scores (step 320). In some implementations, the students can be assigned to quadrant prioritizations by a module such as the quadrant prioritization engine 220 shown in FIG. 2. For example, based on the risk scores for each student, the quadrant prioritization engine may determine that certain students should be prioritized more highly than others, as they may be more likely to benefit from more aggressive communications sent by the administration. On the other hand, the quadrant prioritization engine may determine that some students are unlikely to benefit from additional communications, and may assign such students may to lower quadrant prioritization levels as a result. The quadrant prioritization engine may assign students to any number of quadrant prioritization levels. For example, in some implementations, the quadrant prioritization engine may assign students to any of two, three, four, five, or six quadrant prioritization levels. In some implementations, the quadrant prioritization engine may assign students to more than six quadrant prioritization levels.

In some implementations, the method 300 can include determining weightings for each of a plurality of communication strategies based on a plurality of risk factors (step 330). In some implementations, a module such as the communication strategy engine 240 shown in FIG. 2 can be configured to determine the weightings for each of the plurality of communication strategies based on the plurality of risk factors. For example, the communication strategy engine can be configured to generate a weighting for each of a plurality of risk factors based on various communication strategy types. In one example, the communication strategy type may relate to registration, which may involve encouraging students to register for courses that do not have existing financial blocks to registration. In another example, the communication strategy type may relate to completing a financial aid checklist. For each communication strategy, the communication strategy engine can be configured to generate a weighting for the various risk factors, which may include risk factors associated with procrastination, academics, finances, and demographics of the students, as described above.

In some implementations, the method 300 can include identifying resources available for the communication campaign (step 340). Resources can include any type or form of asset that may be useful for the communication campaign. In some implementations, resources can include physical items, such as mobile phones, tablet computing devices, laptop computers, desktop computers, or servers that are available for use in the communication campaign. In some implementations, identifying the amount of available resources can include taking into account the characteristics of such physical assets. For example, the amount of available resources may be impacted not just by the number of various computing devices or other items that are available for the communication campaign, but also by processing speeds, available memory, bandwidth, and network speed associated with such computing devices. In still other implementations, resources can include human capital. For example, human capital may represent the number of man-hours available for communicating with students using active channels, such as telephone or email, which may require time and effort by employees of the administration. In some implementations, the amount of available resources may be determined by administrators of the academic institution and transmitted to a communication campaign manager 120 such as the communication campaign manager 120 shown in FIG. 2. In some implementations, the method 300 also can include determining a priority level of the communication campaign (step 350). Priority level may indicate how important the campaign is, relative to other communication campaigns which may also require resources similar to those described above, such as computing resources, networking resources, and human capital. In some implementations, the priority level for the campaign also may be determined by administrators of the academic institution and transmitted to the communication campaign manager.

In some implementations, the method 300 can include selecting an order for communicating with the students based on the quadrant prioritization for each student, the weightings for each communication strategy, the available resources, and the priority level of the communication campaign (step 360). In some implementations, this step can be performed by a module such as the communication campaign generator 250 shown in FIG. 2. For example, the communication campaign generator can be configured to process the information generated or otherwise provided by other modules that may be included in the communication campaign manager 120 shown in FIG. 2, as well as additional information that may be provided by the administrator devices 270 (also shown in FIG. 2), to produce a communication campaign that can be used to help improve student outcomes. The communication campaign may include a list of students arranged by the order in which the students should be communicated with to achieve the best results.

In some implementations, the method 300 can also include executing the communication campaign based on the priority level of communications the selected order in which the communications are to be transmitted to students. In some implementations, the communication campaign can be executed by the communication campaign generator to help improve student outcomes. In some implementations, the communication campaign generator can be configured to select communication channels over which communications for the campaign should be delivered to students. For example, such channels may include emails, telephone calls, text messages, paper mail, or push notifications delivered to student devices such as the student devices 280 shown in FIG. 2. As discussed above, the student devices can be configured to execute a mobile application that facilitates the communication campaign. In some such implementations, the communication campaign generator can cause the communications of the campaign to be sent to the student devices via the mobile application, such as via push notifications associated with the mobile application. Furthermore, the communication campaign generator may send other types of information to the student devices, such as information corresponding to calendar appointments for one or more calendar applications that may execute on the student devices. In some implementations, the communication campaign generator may generate and transmit to the student devices messages that request information from the students. For example, such messages may request that the students provide information (e.g., in the form of a survey) relating to their knowledge or level of completion for various administrative processes. In some implementations, the communication campaign generator also can receive and store information provided by the students in response to such communications.

In some aspects, the methods of the present solutions implements a combination of steps in an innovative, non-conventional and/or non-routine manner. In some aspects, the method of the present solution combines the steps of FIG. 3 in an innovative, non-conventional and/or non-routine combination to implement the improved functionality, performance and operation of the present solution. In some aspects, the method of the present solution combines the steps of FIG. 3 in an innovative, non-conventional and/or non-routine manner to more efficiently and effectively use computing and networking resources. In some aspects, the method of the present solution provides innovative, non-conventional and/or non-routine ordered combination of steps.

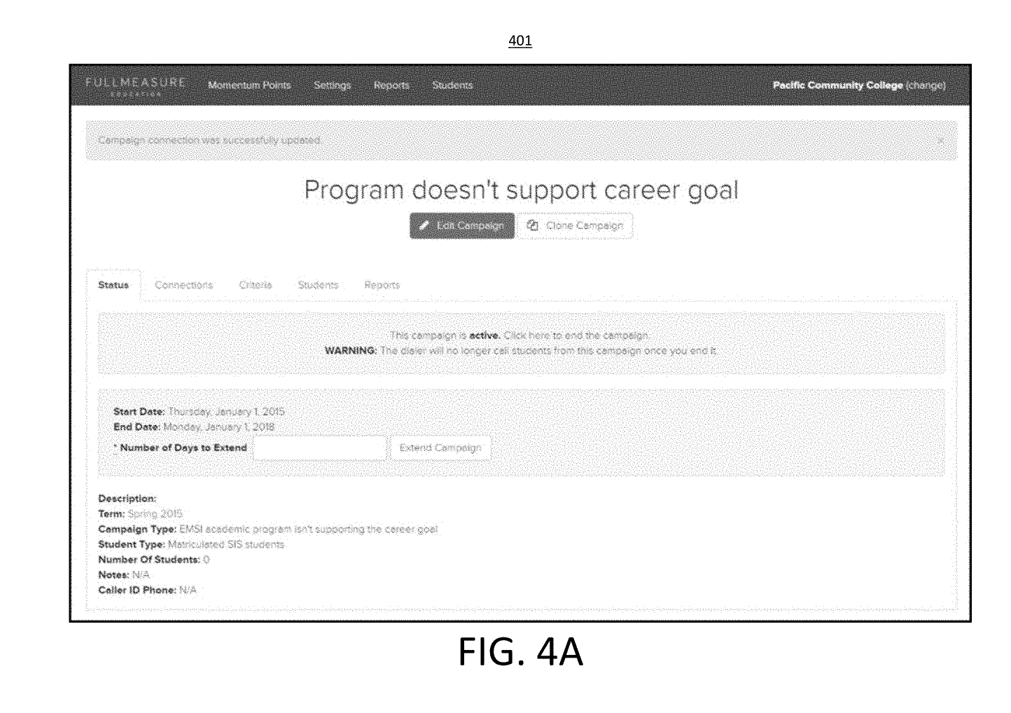

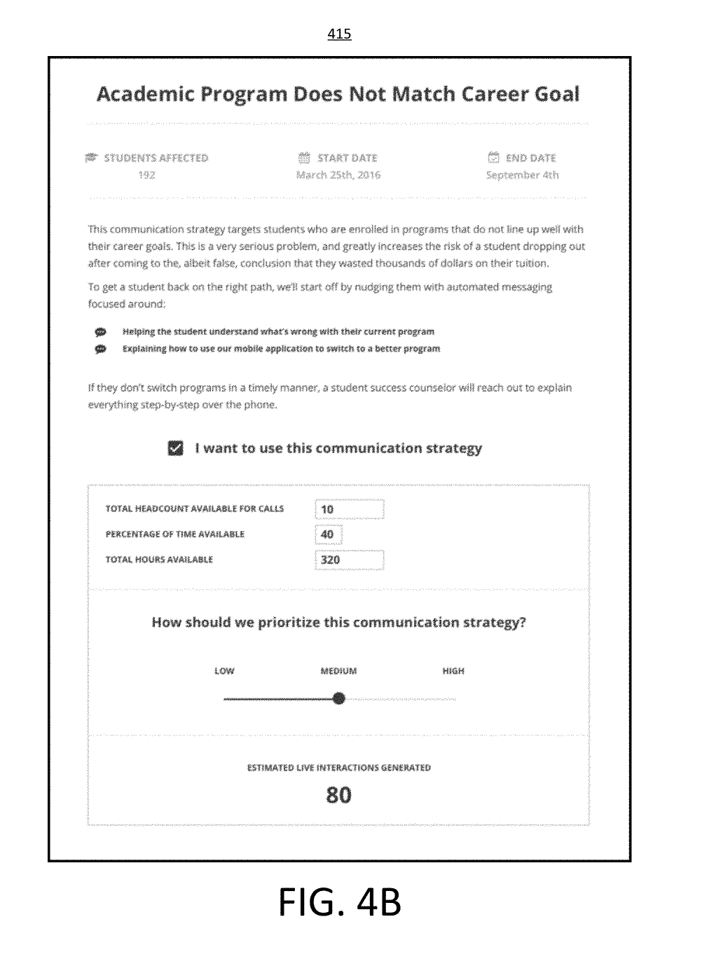

FIGS. 4A and 4B are screenshots of example graphical user interfaces (GUIs) for managing an electronic communication campaign. In particular, FIG. 4A shows an example GUI 401 for providing an alert when a student's academic program is not matched with the student's career objectives. In some implementations, the GUI 401 may be suitable for display on a mobile computing device. For example, as discussed above, in some implementations the administrator devices 270 shown in FIG. 2 may be configured to execute mobile applications, and the GUI 401 may be displayed as part of such a mobile application on a mobile device. However, it should be understood that in some implementations, the information contained within any of the GUI 401 could instead be formatted for other types of computing devices. For example, the GUI 401 can be formatted in such a way as to be suitable for display on desktop computing devices, laptop computing devices, tablet computing devices, mobile computing devices, or any other type of computing device. In some implementations, the GUI 401 can be displayed as a part of an application or other computer program that executes on the computing device on which the GUI 401 are displayed. In some implementations, the information displayed in the GUI 401 can be generated or otherwise provided to the computing device by a communication campaign manager such as the communication campaign manager 120 shown in FIG. 2.

In some implementations, the GUI 401 can be displayed on a computing device such as one of the administrator devices 270 shown in FIG. 2. For example, the GUI 401 can alert an administrator that the current academic program for a particular student does not match that student's career objectives. As shown, the GUI 401 includes a message indicating that an academic program does not support the career goals of at least one student, and indicates that the message is part of an active communication campaign. The GUI 401 includes a selectable link that can allow a user to end the campaign. In some implementations, the selectable link can be selected by a mouse, a stylus, or another form of pointing device. The GUI 401 also includes a button allowing a user (e.g., an administrator) to edit the campaign manually. For example, selecting the “Edit Campaign” button may allow the user to modify features of the communication campaign, such as the list of students who are to be contacted during the campaign, the amount of human capital (e.g., man-hours) allocated for the campaign, or the priority level of the campaign. The GUI 401 also includes a field into which a user may enter text indicating a number of days to extend the campaign beyond a scheduled end date.

FIG. 4B shows an example GUI 415 for modifying a communication campaign. Like the GUI 401 shown in FIG. 4A, the GUI 415 may be suitable for display on any form of computing device, including desktop computing devices, laptop computing devices, tablet computing devices, mobile computing devices, or any other type of computing device. Similar to the GUI 401, the GUI 415 also may be displayed on a device such as the administrator devices 270 shown in FIG. 2. In some implementations, the GUI 415 can be displayed as a part of an application, such as a mobile application executing on a mobile administrator device as discussed above, or other computer program that executes on the computing device on which the GUI 415 are displayed. In some implementations, the information displayed in the GUI 415 can be generated or otherwise provided to the computing device by a communication campaign manager such as the communication campaign manager 120 shown in FIG. 2.

In some implementations, the GUI 415 can be generated as a result of a user selecting the “Edit Campaign” button of the GUI 401 shown in FIG. 4A. Thus, the GUI 415 includes various user-editable fields that allow a user to modify the campaign for communicating with students whose academic programs do no match their career goals. A user (e.g., an administrator) can use the GUI 415 to change the amount human capital allocated to the campaign, for example by adjusting the values associated with the total headcount available for calls, the percentage of time available, or the total hours available. In addition, the user can also select a low, medium, or high priority for the campaign. The GUI 415 also provides additional information to the user, such as the number of students affected (e.g., the number of students whose academic programs do no match up with their career goals), the start date for the campaign, the end date for the campaign, and a description of the problem addressed by the campaign.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary embodiments and should be defined in accordance with the accompanying claims and their equivalents.

What is claimed is:

1. A method for selecting an order of communications based on risk scores and resources, the method comprising:
(a) determining, by a risk scoring engine executing on one or more devices, a risk score for each of a plurality of students based on information on each of the plurality of students stored in a database;
(b) assigning, by a quadrant prioritization engine executing on the one or more devices, each of the plurality of students to a quadrant level of a plurality of quadrant levels based on the risk score determined for each of the plurality of students;
(c) assigning, by a communication campaign generator, a level of resources from a predetermined plurality of resources to each quadrant level;
(d) selecting, by the communication campaign generator, an order for communicating with the plurality of students based on the quadrant level assigned to each student and the level of resources assigned to each quadrant level; and
(e) communicating, by the communication campaign generator, to each of the plurality of students based on the selected order.

2. The method of claim 1, wherein (a) further comprises determining, by the risk scoring engine, for each student the risk score corresponding to a risk score category of a plurality of risk score categories.

3. The method of claim 1, wherein (a) further comprises determining the risk score based on information comprising demographic information, financial aid information and academic information.

4. The method of claim 1, further comprising determining, by a communication strategy engine, weightings for each of a plurality of communication strategies based on a plurality of risk factors.

5. The method of claim 4, wherein (d) further comprises selecting the order based on the quadrant level assigned to each student and the level of resources assigned to each quadrant level and the weightings for each of the plurality of communication strategies.

6. The method of claim 4, further comprising determining weightings based on relevance of risk score category to type of communication strategy.

7. The method of claim 1, wherein (d) further comprises determining, by the communication campaign generator, a priority level for each of a plurality of communication campaigns to be communicated to one or more of the plurality of students.

8. The method of claim 7, wherein (d) further comprises selecting the order based on the quadrant level assigned to each student and the level of resources assigned to each quadrant level and the priority level of each of the plurality of communication campaigns.

9. The method of claim 1, wherein (d) further comprises selecting at least one communication channel from a plurality of communication channels over which a communication campaign is to be communicated to one or more of the plurality of students.

10. The method of claim 9, wherein the plurality of communication channels comprises at least two or more of the following: email, text, telephone and push notifications via an application.

11. A system for selecting an order of communications based on risk scores and resources, the system comprising:
one or more devices comprising a processor, coupled to memory;
a risk scoring engine executable on the one or more devices and configured to determine a risk score for each of a plurality of students based on information on each of the plurality of students stored in a database;
a quadrant prioritization engine executable on the one or more devices and configured to assign to each of the plurality of students to a quadrant level of a plurality of quadrant levels based on the risk score determined for each of the plurality of students;
a communication campaign generator executable on the one or more devices and configured to:
assign a level of resources from a predetermined plurality of resources to each quadrant level;
select an order for communicating with the plurality of students based on the quadrant level assigned to each student and the level of resources assigned to each quadrant level; and
communicate to each of the plurality of students based on the selected order.

12. The system of claim 11, wherein the risk scoring engine is further configured to determine for each student the risk score corresponding to a risk score category of a plurality of risk score categories.

13. The system of claim 11, wherein the risk scoring engine is further configured to determine the risk score based on information comprising demographic information, financial aid information and academic information.

14. The system of claim 11, further comprising a communication strategy engine configured to determine weightings for each of a plurality of communication strategies based on a plurality of risk factors.

15. The system of claim 14, wherein the order is selected based on the quadrant level assigned to each student and the level of resources assigned to each quadrant level and the weightings for each of the plurality of communication strategies.

16. The system of claim 14, wherein the communication strategy engine is further configured to determine weightings based on relevance of risk score category to type of communication strategy.

17. The system of claim 11, wherein the communication campaign generator is further configured to determine a priority level for each of a plurality of communication campaigns to be communicated to one or more of the plurality of students.

18. The system of claim 17, wherein the order is selected based on the quadrant level assigned to each student and the level of resources assigned to each quadrant level and the priority level of each of the plurality of communication campaigns.

19. The system of claim 11, wherein at least one communication channel from a plurality of communication channels is selected over which a communication campaign is to be communicated to one or more of the plurality of students.

20. The system of claim 19, wherein the plurality of communication channels comprises at least two or more of the following: email, text, telephone and push notifications via an application.
